(19) United States
(12) Patent Application Publication
(10) Pub. No.: US 2007/0149164 A1
(43) Pub. Date: Jun. 28, 2007

(54) Intermediate modulator for wireless communication devices

(75) Inventor: C.M. Wong, Ontario (CA)

Correspondence Address: JAMES ALAN FRANKLIN, 7901 RAVENSWOOD RD, GRANBURY, TX, 76049, US

(73) Assignee: MAGNADYNE CORPORATION, COMPTON, CA (US)

(21) Appl. No.: 11/319,342

(22) Filed: Dec. 27, 2005

Related U.S. Application Data
(60) Provisional application No. 60/691,670.

(51) Int. Cl. H04H 7/00; H04B 1/08

(52) U.S. Cl. 455/349; 455/3.06

(57) ABSTRACT

A device facilitating transmission of audio content to an audio device such as an FM or AM radio, through a wireless communication device, such as a cell phone. The wireless communication device downloads the content from a remote depository and provides the content to a bridge comprising a FM or AM modulates the content onto a carrier frequency for transmission and receipt of such content by a radio receiver.

### CROSS-REFERENCE TO RELATED APPLICATION

This application claims priority to co-pending United States provisional application entitled, “VPA/FM Hands-Free Transmitter,” having Ser. No. 60/691,670, filed Jun. 16, 2005, which is entirely incorporated herein by reference.

### BACKGROUND

1. Field

The disclosed embodiments relate generally to the delivery of audio information to audio systems through wireless devices, such as cell phones.

2. Discussion of the Prior Art

The wireless revolution has gripped our society with unprecedented attachment rate and consumer enthusiasm. Cell phones, at first expensive and uncommon, today are a commodity and for most a staple of every day life. Range of use is expansive. People use cell phones as safety devices, as means to stay in touch with friends and family, and even as entertainment pods. One can download games, ring tones, pictures, music files and world wide web content.

Another area of explosive enhancement is the audio industry. Not long ago, FM radios were a value-add item, delivering higher fidelity and sold at a premium in vehicles and home use. With time, FM radios became commonplace. Now almost every vehicle is shipped with an FM band radio and almost every home has one or more FM radio receivers.

Another relatively recent phenomenon is the ability for a user to download music from a central depository, such as his/her own music bank, or a vendor music bank that charges a fee. Such use if further fueled by the introduction of iPod brand players, which are essentially portable disk drive appliances that are optimized for storage and play of music content. The source of music files is one's computer, which downloads the digital music files from either the user's music compact disk (CD) or from a central depository, such as a third party server. Some servers allow one to download the content free of charge and others charge for this service and the content.

Cell phones are also evolving as entertainment pods. Cell phone providers allow its users to access the world-wide-web/internet to download information, check electronic mail, search the web, download games, ring tones, and music. Once the music files are downloaded, the user can listen to it through the phone's miniature speaker or headphones. However, the user does not have the means to display/play the downloaded content through the electronic appliances in the vehicle, such as its audio equipment, typically including a radio receiver, which typically provides better fidelity sound than a cell phone.

### SUMMARY

The disclosed embodiments provide a bridge device from a communication device, such as a cell phone, to an audio device, such as the vehicle's audio equipment comprising an FM or AM radio receiver. The digital audio content in the communication device is communicated to a bridge device that accepts and/or derives the downloaded content and then frequency or amplitude modulates (FM, AM) it. The bridge device then transmits the FM or AM signal to the audio equipment through its antenna.

The disclosed embodiments foresee that the digital content could be compressed or uncompressed. For example, the content delivered to the communication device could be uncompressed. In which case, the content then flows to the audio equipment through the described bridge. On the other hand, the content could be delivered in an MP3 format. Therefore, at one or more points in the chain of the communication device, the bridge device and the audio equipment, such content will be decompressed.

### BRIEF DESCRIPTION OF THE DRAWINGS

FIG. 1 illustrates a representative diagram of two exemplary embodiments;

FIG. 2 illustrates a representative diagram of an alternate exemplary embodiment, wirelessly coupling the communication device with the bridge device;

FIG. 3 illustrates a diagram of an alternate embodiment, wherein the bridge device is integrated into the communication device.

### DETAILED DESCRIPTION

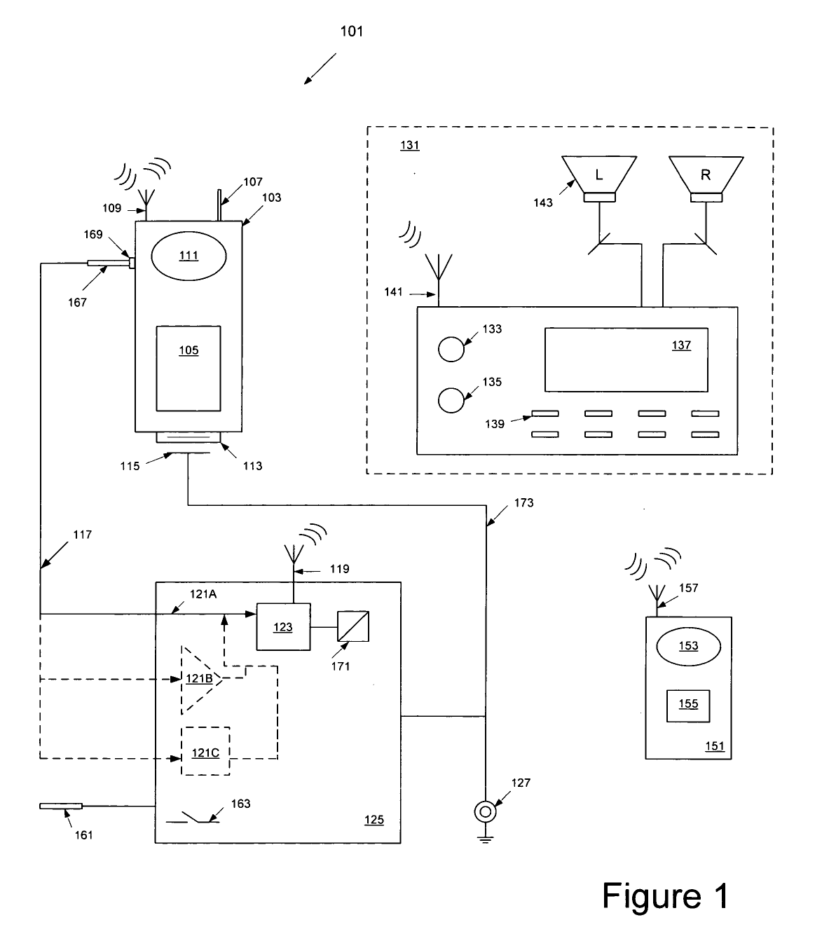

Shown in FIG. 1, is a representative embodiment of the disclosed system 101. System 101 generally comprises a wireless communication device 103, such as a cell phone, including an integral audio display device, such as an audio transducer/speaker 111. It is understood, however, that the structure described herein will work equally well with any wireless communication device capable of downloading digital files. For example, it is foreseeable that portable computers or PDAs may have such capability and any such devices are within the scope of device 103. Looking far enough in advance, such capability may exist on a wristwatch as well.

Typically, the downloaded files reach device 103 through its antenna 107, which could be in or out of physical view to the user. Device 103 then employs a decoder 105 to decode the signal in accordance with the protocols, algorithms and/or specifications (collectively “protocols”) defined by the network carrier. For example, the predominant protocols today are CDMA and GSM, although such protocols have no impact on the disclosed embodiments. Once the downloaded files are decoded, they are stored in a memory or buffer (not shown). Such memory is typically aboard one or more of the described devices. One may also store such files on a removable memory medium (not shown) such as a memory card or a disk for subsequent play on the device 103 or other devices. The derived files may have arrived in compressed form. A common compression protocol for music files is MP3. Other protocols may also be used. Accordingly, decoder 105 is also configured with the ability to recognize one or more compression protocols, such as MP3 and as a part or in addition to its decoding function, to decompress the downloaded file in accordance with one or more of such protocols. Once decompressed, typically the wireless device is ready to display the audio content through its speaker 111 or to provide the audio signal to external ear phone(s).

Yet in another embodiment, device 103 may also comprise intermediary transmission capability, wherein the received files are broadcast from device 103 to other devices. One such intermediary transmission protocol is commonly referred to as Bluetooth. It is an industry adopted protocol for relatively short range transmission of digital information. In one alternate embodiment, device 103 is Bluetooth enabled and it broadcasts the downloaded digital files via its antenna 109 to receivers or transceivers in its vicinity, such as a transceiver 151.

Once the intermediary signal is sent by device 103, one or more remote receivers can receive the signal. In one example a remote transceiver 151 receives the signal via its antenna 157. In this particular example, device 151 is a wireless transceiver or headset used to communicate audio information to and from the wireless communication device 101. This device is configured for removable attachment about the user's ear and it allows the user to communicate with another party through his/her cell phone 103. Transceiver 151 employs an audio transducer 153 to display the audio content to the user. As in the case of audio transducer 111, audio transducer 153 could be a magnetic or a piezo speaker, earbud(s) or a headphone. Given its function, transceiver 151 also typically includes a microphone 155 that generates an electrical signal in response to the audio energy that it senses. In turn, transceiver 151 transmits the generated audio signal back to device 103 via the Bluetooth protocol or one or more other intermediary transmission protocols. One of ordinary skill in the art will recognize how to digitize the electrical signal generated by microphone 155, encode it as a Bluetooth signal and transmit it back to device 103 via its antenna 157. One will also appreciate that transceiver 151 in this embodiment comprises a decoder (such as Bluetooth decoder) for decoding the intermediary signal, a digital to analog converter and an amplifier, configured to generate the audio signal at transducer speaker 153. Similarly, one will also appreciate that transceiver 151 in this embodiment comprises the blocks necessary for the reverse link, including without limitation an analog to digital converter, signal conditioning circuitry, an encoder (such as Bluetooth encoder) for encoding the intermediary signal for transmission to the wireless communication device 103 and other devices in its vicinity. Some remote devices are receivers only. An example is a wireless headset. Such devices would typically employ only receiving and decoding functionality. Other devices, such as the described headset 151, need a two-way capability, and therefore employ receiving, transmitting, encoding and decoding functionality.

As mentioned above, a typical communication device 103 has the inherent ability to display the audio content of downloaded files through its display device 111. However, in some environments, display device 111 is insufficient. In one example, speaker 111 may not be powerful enough in a noisy environment, it may not have sufficient quality characteristics, or the user simply wants to take advantage of the utility and the convenience of the audio equipment 131 in the vicinity. Missing, however, is the link between the device 103 and audio equipment 131.

In its simplified form, typical audio equipment device 131 comprises a tuner/amplifier (not shown) connected to an antenna 141, displaying the audio content through one or more speakers 143. Commonly this combination is referred to as a radio or a radio receiver. More particularly, audio equipment 131 is configured to receive a signal comprising audio content on a carrier frequency that is frequency modulated (FM) or amplitude modulated (AM). The carrier frequencies are picked up by antenna 141 and are fed to an input of an AM or FM tuner and then a FM or AM demodulator. The tuner then looks at the signal from antenna 141 about the frequency parameters selected by the user. Typically the user will use one of the control knobs such as knob 133 to select the frequency, often referred to as the “channel” or “station.” Also common, is for the user to preset the stations he/she often listens to and store them in registers invoked by switches 139. Therefore, if a user has a preference for a station, he/she would program that station frequency in the resident memory and recall that frequency by pressing switch 139. Often, the selected frequency information, such as the station name, the frequency number, control information such as volume, and other pertinent data are displayed on display 137. The other control knob 135 optionally allows the user to control other parameters of the audio equipment 131, such as volume, tuning, balance between the speakers, and sound tone. Once the tuner tunes to the selected frequency, the demodulator of audio equipment 131 in turn derives the audio content. That content is then amplified and displayed through one or more audio transducers/speakers 143.

As mentioned above, although audio equipment device 131 and wireless communication device 103 are both receiving information wirelessly, they are incompatible. They operate using fundamentally different technologies, different frequencies and different protocols.

Described is bridge 125 bridging device 103 and audio equipment 131, using one of the established FM or AM protocols. Depending on the manufacturing and marketing criteria, its power source 127 could be a battery, onboard power source gathered by plugging into a harness or the cigarette lighter of a vehicle, or any other power means. In one embodiment, demodulator 105 decodes the received signal to derive the digital file. As mentioned above, the downloaded file(s) may also be compressed using one of a number of available compression protocols. One of the more common protocols for music content is the MP3 compression. Others exist as well. One of ordinary skill in the art would be able to put in the right components to handle the protocols and formats of the incoming signals and data to extract the digital file representing the downloaded music content. The functional or hardware blocks may be separate from or integral to decoder 105 without detracting from the contribution of the disclosed embodiments.

In one embodiment, demodulator 105 converts the downloaded file(s) into its analog audio content. The content is then displayed through audio transducer/speaker 111 and/or provided to bridge 125 and/or transceiver 151 and/or other devices. Described next are embodiments collectively illustrated as bridge 125. However, it is understood that any configuration alone or in combination with one or more of the disclosed embodiments denoted by blocks 121A and 121B and communication paths between device 103 and 125 are within the scope of this description.

In one embodiment, the audio content is received by device 103, demodulated, decompressed, if received in compressed form, and the digital information is converted to an analog signal. Typical compression protocol for music files is MP3. Although any compression protocol is suitable, as long as the wireless communication device 103 is configured with the corresponding decompression protocol. The analog signal is provided to bridge 125 via a wired path 117. In this embodiment the signal follows a path 121A, which leads it directly to or through some signal conditioning to FM or AM modulator 123. On one end, wired path 117 terminates in a connector 167, which is configured for compatibility with connector 169 of device 103. Typically connector 169 is an ear-bud or headphone connector configured to operate with headsets for cell phones. On the other end, wired path 117 is hardwired into bridge 125 or is configured for removable connection with bridge 125 using a suitable connector pair. After some signal conditioning or signal processing such as an attenuator (not shown), modulator 123 then FM or AM modulates (or any other modulation compatible with audio equipment 131) the audio content received from device 103 on a signal with a frequency (channel or station) compatible for receipt by audio equipment 131. Shown in FIG. 1 is a frequency selector 171. It allows the user to choose the center frequency for such modulation. However, one or several defined frequency selections may also be used. Embodiment employing frequency selector 171 allows the user to define the frequency on which the downloaded content will be sent to audio equipment 131. This avoids the potential of having a predefined frequency overlap with a station frequency preferred by the user and it allows the user to select one or more frequencies that are relatively noise free. The modulated signal is then transmitted through antenna 119 to antenna 141 of audio equipment device 131. Audio equipment device 131 in turn demodulates the signal and displays its content through one or more speakers 143.

Power is provided to bridge 125 from a power source 127, which typically ranges from 11 Vdc to 15 Vdc, although any current or power source could be conditioned to suitable parameters. In one of the embodiments power source 127 is accessible through a cigarette lighter port typically available in a vehicle. However, any port having one or more power outputs will suffice. Depending on the design, the power is then channeled via path 173 to bridge 125 and optionally to device 103. Device 103 may use such power availability to recharge its internal power reserves. At 103, path 173 terminates in a connector 115 compatibly suitable for connection with connector 113. In an alternate embodiment power source 127 represents battery power reserves available internally or externally to bridge 125. Once again, one may extend that reserve to device 103 via path 173. Shown is a microphone 161 allowing the user to communicate with another party over device 103 or to provide audible commands to device 103 and/or audio equipment 131, device 125 and/or any other device in the system. Microphone 161 may be integrated into path 117 or 173 stemming from the power plug 127 leading to device 103, essentially substituting for the headset microphone. However, microphone 161 may be placed at any point in the vicinity of the user.

In one embodiment, path 173 may be configured as a stretchable wire coil. As a coil, the physical connection is more manageable and efficient, especially in a relatively confined space typical of a vehicle environment. Such design is more compact and yet it accommodates some movement while minimizing the wire tangling associated with longer wired paths. One or more switches and/or soft switches 163 may be employed to switch on and off the functionality of bridge 125 and/or mute microphone 161. Switch 163 could also be used to pick up an incoming call or terminate a call.

Bridge 125 may also be integrated with path 173 and/or into the male cigarette lighter plug typically associated with an in-cabin power connection. Such plugs typically accommodate enough physical space for the user to grip and insert the plug into the female power receptacles. In one embodiment, bridge 125 is integrated into the body of the male plug 127. Of course, such integration is not functionally necessary, although logically desirable for efficiency and aesthetics. Bridge 125 could also be designed as a separate physical module configured for interoperability as described throughout this disclosure.

In another embodiment, path 121B is employed. This embodiment accepts the audio content in its digital form from device 103 through wired path 117. The physical connection in this embodiment could vary, but one logical choice is USB. In this embodiment, connectors 167 and 169 are corresponding USB connectors. The audio content is received by device 103, demodulated by demodulator 105, as applicable decompressed and provided to bridge 125 or decompressed at 125. Logically, the decompression would take place at demodulator 105 of communication device 103, since device 103 will likely have such decompression protocol and the necessary hardware for this and other applications. However, the same capabilities could be placed in bridge 125. Once the content file is derived, either at device 103 or at bridge 125, bridge 125 is configured to employ a digital to analog converter (DAC) 121B. DAC 121B converts the digital content into an analog signal and provides it to modulator 123. As described above, modulator 123 then FM or AM modulates (or any other modulation compatible with audio equipment 131) the audio content received from device 103 on a signal with a frequency (channel, station) compatible for receipt by audio equipment 131. The modulated signal is then transmitted through antenna 119 to antenna 141 of audio equipment device 131. Audio equipment 131 in turn demodulates the signal and displays its content through one or more speakers 143.

It is understood that the dashed line and the inclusion of illustrated blocks 121A and 121B suggest that depending on the design criteria, one could adopt any one of the alternate embodiments. One could also choose to include both of the described embodiment into a single device.

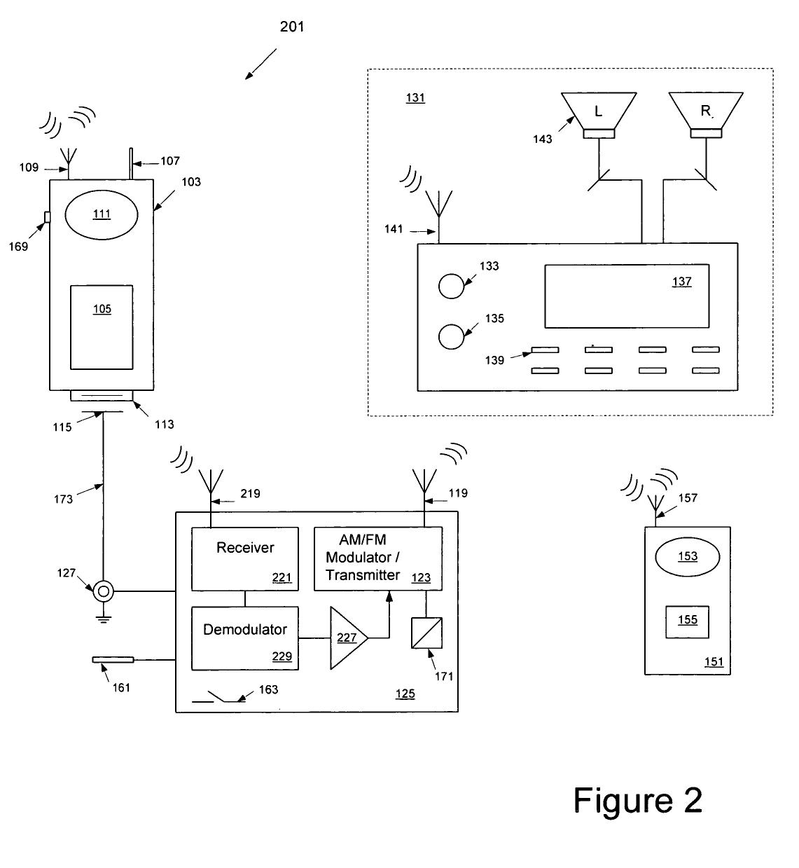

Shown in FIG. 2 with more particularity is the embodiment wherein device 103 and bridge 125 are configured for wireless connection using an intermediate transmission protocol such as Bluetooth. In this embodiment block 105 decodes the downloaded information into a digital file as well as encodes the downloaded digital content using the parameters of the intermediate transmission protocol such as Bluetooth. If the content is compressed, in some embodiments the content is sent after block 105 decompresses it. In other embodiments, the content is passed in its compressed form. If provided to bridge 125 in its compressed form, then bridge 125 would be configured with the requisite hardware and/or software for decompression. As mentioned before, MP3 is a common compression protocol for music files. Device 103, vis-à-vis its modulator 105 and antenna 109, encodes and broadcasts the audio content using intermediary transmission protocols such as Bluetooth. Bridge 125 is configured to receive the broadcast content vis-à-vis its antenna 219 that is coupled to a receiver 221. Receiver 221 and demodulator 229, configured to decode one or more intermediary transmission protocols such as Bluetooth receive and derive the content from the received signal. If the content is received in its compressed form, such as MP3 format, demodulator 229 further decompresses it. The digital content is then conditioned and/or converted at 227 to an analog signal. The analog signal is provided to modulator 123. Depending on the chosen embodiment, modulator 123 FM or AM modulates the signal onto a carrier frequency and transmits it through antenna 119 to antenna 141 of audio equipment 131. The carrier frequency is either predefined or is chosen vis-à-vis selector 171. Audio equipment 131 in turn demodulates the signal and displays its content through one or more speakers 143.

As above, power is provided to bridge 125 from a power source 127, which typically ranges from 11 Vdc to 15 Vdc. In one of the embodiments power source 127 is accessible through the cigarette lighter port typically available in a vehicle. However, any port having one or more power outputs will suffice. Depending on the design, the power is then conditioned and channeled via path 173 to bridge 125 and optionally to device 103. Device 103 may use such power availability to recharge its internal power reserves. At 103, path 173 terminates in a connector 115 compatibly suitable for connection with connector 113. In an alternate embodiment power source 127 represents battery power reserves available internally or externally to bridge 125. Once again, one may extend that reserve to device 103 via path 173.

Shown is a microphone 161 allowing the user to communicate with another party over device 103 or to provide audible commands to device 103, device 125 and/or any other device in the system. Microphone 161 may be integrated into bridge 125 and/or path 173. However, microphone 161 may be placed at any point in the vicinity of the user. In one embodiment, path 173 may be configured as a stretchable wire coil. As a coil, the physical connection is more manageable and efficient, especially in a relatively confined space typical of a vehicle environment. Such design is more compact and yet it accommodates some movement while minimizing the wire tangling associated with longer wired paths. One or more switches and/or soft switches 163 may be employed to switch on and off the functionality of bridge 125 and/or mute microphone 161. Switch 163 could also be used to pick up an incoming call or terminate a call.

Bridge 125 may also be integrated with path 173 and/or into the male cigarette lighter plug typically associated with an in-cabin power connection. Such plugs typically accommodate enough physical space for the user to grip and insert the plug into the female power receptacles. In one embodiment, bridge 125 is integrated into the body of the male plug 127. Of course, such integration is not functionally necessary, although logically desirable for efficiency and aesthetics. Bridge 125 could also be designed as a separate physical module configured for interoperability as described throughout this disclosure.

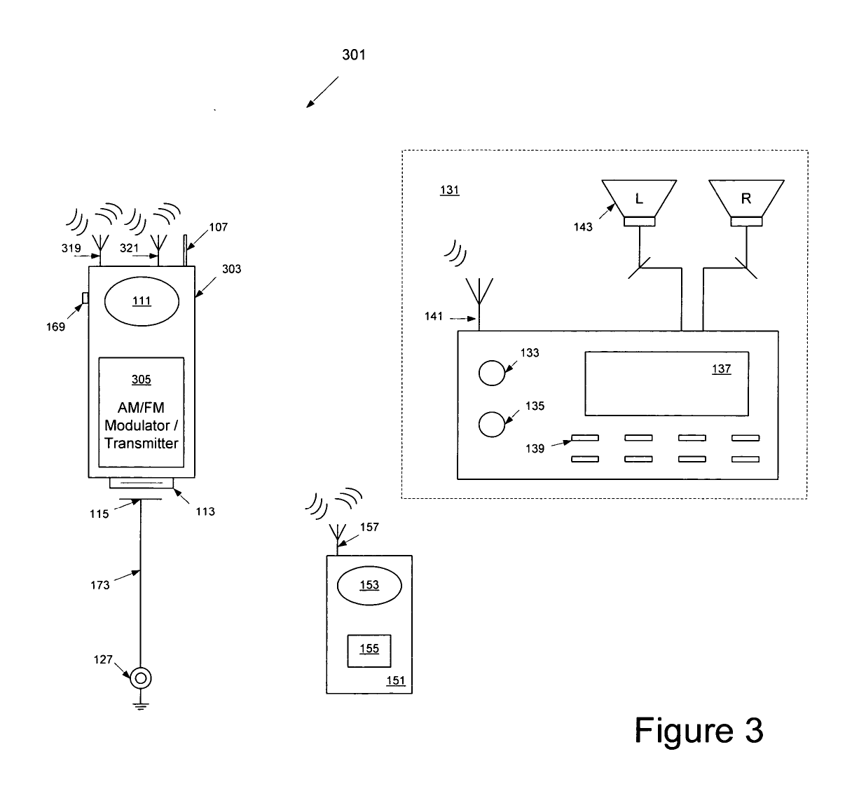

Shown in FIG. 3 is an alternate embodiment, illustrating system 301. In this system the functionality of device 103 and bridge 125 are integrated into a wireless communication device 303. In this embodiment device 303 receives the downloaded audio content as described above. The modulator/transmitter 305 is configured to decode, decompress (if needed) and extract the downloaded content and then transmit the same to device 151, consistent with the intermediary transmission protocols described above. The modulator/transmitter 305 additionally has the capability of converting the downloaded content to an analog signal as described above, and FM or AM modulating the analog signal for transmission to audio equipment 131 vis-à-vis antenna 321. Also shown is antenna 319, which is used for the described intermediary (Bluetooth as an example) transmission. Audio equipment device 131 in turn demodulates the signal and displays its content through one or more speakers 143. As in other embodiments, power is optionally provided to bridge 125 from a power source 127 via path 173. Device 303 may use such power availability to recharge its internal power reserves. At 303, path 173 terminates in a connector 115 compatibly suitable for connection with connector 113. In an alternate embodiment power source 127 represents battery power reserves available internally or externally to device 303.

An internal microphone is typically available as an integral component of device 303, allowing the user to send communicate back to communicate with another party over the device 303 or to provide audible commands to device 303 and/or any other device in the system.

The disclosed embodiments also allow the audio content of an incoming call to be displayed over audio equipment 131 through bridge 125. In view of the disclosed embodiments herein, the voice content that is ordinarily displayed through one or more audio transducers 111 or 153 could be channeled through bridge 125 and to audio equipment 131 for display through speaker(s) 143.

Notably, depending on the specification of the chosen intermediary transmission protocol, it may be possible to combine antennas 107 and 109; or in the case of the embodiment illustrated in FIG. 3, combine one or more antennas 107, 319 or 321. However, again depending on the protocol specification, it may be advantageous or necessary to use separate antennas. Also worth noting is that other intermediary protocols, such as 802.11, may be used without affecting the scope of the various embodiments disclosed throughout this specification.

While the present description has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth.

I claim:

1. A device comprising:
a) a bridge configured to receive a signal from a wireless communication device, wherein said wireless communication device is configured to wirelessly receive audio content from a remote depository, and to provide to said bridge said audio content as said signal; and
b) said bridge configured to modulate said signal onto a carrier frequency for transmission to a radio receiver.

2. The device of claim 1 wherein said signal is an analog signal.

3. The device of claim 1 wherein said communication device is a cell phone.

4. The device of claim 1 wherein said bridge frequency modulates said signal.

5. The device of claim 1 wherein said bridge amplitude modulates said signal.

6. The device of claim 1 further comprising a path configured to provide power to said bridge and said wireless communication device.

7. The device of claim 1 further comprising a path for transmission of said signal from said wireless communication device to said bridge, said path further comprising a connector compatible with a headset connector of said wireless communication device, thereby allowing transmission of said signal from said wireless communication device to said bridge through said path.

8. The device of claim 1 wherein said bridge is configured to receive said signal from said wireless communication device representing audio communication from said at least one other user and to modulate said signal onto said carrier frequency for transmission to said radio receiver.

9. The device of claim 8 further comprising a microphone for communication of audio information from one person to at least one other person through said wireless communication device.

10. The device of claim 1 further comprising a frequency selector allowing selection of said carrier frequency.

11. The device of claim 1 further comprising at least one switch configured to exercise at least one function of said wireless communication device.

12. The device of claim 1 further comprising at least one speaker connected to said radio receiver for displaying said audio content.

13. The device of claim 1 wherein said bridge and said wireless communication device are configured for wireless communication.

14. The device of claim 1 wherein said bridge and said wireless communication device are integrated into a common housing.

15. The device of claim 1 wherein said wireless communication device is further configured to decompress said audio content.

16. The device of claim 14 wherein said audio content is compressed in accordance with an MP3 compression protocol.

17. The device of claim 1 wherein said bridge is further configured to decompress said audio content.

18. The device of claim 16 wherein said audio content is compressed in accordance with an MP3 compression protocol.

19. A device comprising:
a) a bridge configured to communicate with a wireless communication device, wherein said wireless communication device is configured to wirelessly receive audio content from a remote depository, and to provide to said bridge said audio content as a digitally encoded signal; and
b) said bridge is configured to derive an analog signal from said digitally encoded signal, representing said audio content, and to modulate said analog signal onto a carrier frequency for transmission to a radio receiver.

20. The device of claim 19 wherein said digitally encoded signal is encoded using MP3 encoding.

21. The device of claim 19 wherein said communication device is a cell phone.

22. The device of claim 19 wherein said bridge frequency modulates said analog signal.

23. The device of claim 19 wherein said bridge amplitude modulates said analog signal.

24. The device of claim 19 further comprising a path configured to provide power to said bridge and said wireless communication device.

25. The device of claim 19 further comprising a path in accordance with a USB protocol for transmission of said digitally encoded signal from said wireless communication device to said bridge.

26. The device of claim 19 wherein said bridge is configured to receive an analog signal from said wireless device representing an audio communication from at least one other person and to modulate said analog signal onto said carrier frequency for transmission to said radio receiver.

27. The device of claim 26 further comprising a microphone for communication of audio information from said at least one person to at least one other person through said wireless communication device.

28. The device of claim 19 further comprising a frequency selector allowing the selection of said carrier frequency.

29. The device of claim 19 further comprising at least one switch configured to exercise at least one function of said wireless communication device.

30. The device of claim 19 further comprising at least one speaker connected to said radio receiver for displaying said audio content.

31. The device of claim 19 wherein said bridge is further configured to decompress said digitally encoded signal using a MP3 protocol.

32. A device comprising:
a) a bridge configured to wirelessly receive a signal comprising audio content from a wireless communication device, wherein said wireless communication device is configured to wirelessly receive said audio content from a remote depository; and
b) said bridge is configured to derive an analog signal and to modulate said analog signal onto a carrier frequency for transmission to a radio receiver.

33. The device of claim 32 wherein said wireless communication device and said bridge are configured to communicate using a relatively short range wireless protocol.

34. The device of claim 33 wherein said short range protocol is the Bluetooth protocol.

35. The device of claim 32 wherein said communication device is a cell phone.

36. The device of claim 32 wherein said bridge frequency modulates said analog signal.

37. The device of claim 32 wherein said bridge amplitude modulates said analog signal.

38. The device of claim 32 further comprising a path configured to provide power to said bridge and said wireless communication device.

39. The device of claim 32 further comprising at least one switch, wherein said switch is coupled to said wireless communication device to exercise at least one function of said wireless communication device.

40. The device of claim 32 further comprising at least one speaker connected to said radio receiver for displaying said audio content.

41. The device of claim 32 further comprising a frequency selector configured for selecting a center frequency for transmitting of said carrier frequency.
a) a bridge configured to wirelessly receive a signal comprising audio content from a wireless communication device, wherein said wireless communication device is configured to wirelessly receive said audio content from a remote depository; and
b) said bridge is configured to derive an analog signal and to modulate said analog signal onto a carrier frequency for transmission to a radio receiver.

42. The device of claim 32 wherein said signal from said wireless device further comprises an audio communication from at least one person and to modulate said analog signal onto said carrier frequency for transmission to said radio receiver.

43. The device of claim 42 further comprising a microphone for communication of audio information from said at least one person to at least one other person through said wireless communication device.

44. A device comprising:
a) a bridge means configured for communicating with a wireless communication device means, wherein said wireless communication device means is configured for wirelessly receiving audio content from a remote depository, and for providing to said bridge means said audio content as a signal; and
b) said bridge means configured for modulating said signal onto a carrier frequency for transmission to a radio receiver.
